(19) United States
(12) Patent Application Publication
(10) Pub. No.: US 2012/0195668 A1
(43) Pub. Date: Aug. 2, 2012

(54) IMAGE FORMING DEVICE

(75) Inventor: Gaku YAMAMOTO, Kyoto-shi (JP)

(73) Assignee: MURATA MACHINERY, LTD., Kyoto-shi (JP)

(21) Appl. No.: 13/349,079

(22) Filed: Jan. 12, 2012

(30) Foreign Application Priority Data
Jan. 28, 2011 (JP) 2011-016975

(51) Int. Cl. G03G 15/00

(52) U.S. Cl. 399/405

(57) ABSTRACT

An image forming device includes an image forming section that forms an image on one side or both sides of a recording sheet; a main body, in which the image forming section is arranged; a main body discharge section arranged in the main body, and to which the recording sheet is discharged; and a discharge unit that is removable with respect to a side surface of the main body, and connectable to a reverse transportation path to reverse front and back of the recording sheet when forming images on both sides of the recording sheet; wherein the recording sheet can be selectively discharged to the main body discharge section or the discharge unit. The discharge unit includes a discharge tray, a discharge roller, a swinging member to guide the recording sheet to the discharge tray, and a rotation drive portion to rotate the discharge roller and swing the swinging member.

### CROSS-REFERENCE TO RELATED APPLICATIONS

This application claims priority under 35 U.S.C. 119 to Japanese Patent Application No. 2011-016975, filed on Jan. 28, 2011, which application is hereby incorporated by reference in its entirety.

### BACKGROUND OF THE INVENTION

1. Field of the Invention

The present invention relates to an image forming device including a plurality of discharge trays to discharge recording paper, and capable of selectively discharging paper to one of the discharge trays.

2. Description of the Related Art

An image forming device (e.g., multifunction peripheral) having functions of a telephone, a facsimile, and a printer is recently being widely used. Such an image forming device is mounted with various functions with technological development, thus enhancing convenience of a user.

In such an image forming device, a removable discharge unit including the discharge trays is arranged so that the user can use one or more discharge trays as necessary. In such a case, the user can switch the discharge tray for every job or can select the desired discharge tray.

For example, there is known an image forming device configured so that one or more discharge trays can be used by arranging a sorter device at an upper part of a main body and configured so that a switching gate arranged at a branching point of a paper path of the sorter device and a main body discharge tray is operated using a drive source of the sorter device, the device main body not being influenced by vibration and the like with the simplified device configuration.

However, since the image forming device described above has a configuration in which the sorter device is arranged at the upper part of the main body and near the main body discharge tray, the upper side of the main body discharge tray needs to be opened in the relevant image forming device. However, many recent multifunction peripherals have a scanner device arranged on the upper side of the main body discharge tray, and hence the application is limited in such multifunction peripherals.

Furthermore, the image forming device described above does not include a reverse transportation path for reversing the front and the back of a recording medium and thus cannot carry out image forming on both sides of the recording medium, and hence it is limited to a case of carrying out image forming on one side of the recording medium although one or more discharge trays can be used.

### SUMMARY OF THE INVENTION

In view of the above, preferred embodiments of the present invention provide an image forming device capable of freely switching discharging destinations of a recording medium in various print (image forming) modes with a simple device configuration, the image forming device having a high degree of freedom of design.

An image forming device according to a preferred embodiment of the present invention includes an image forming section, a main body, a main body discharge section, and a discharge unit. The image forming section is adapted to form an image on one side or both sides of a recording sheet. The main body is arranged with the image forming section. The main body discharge section is arranged in the main body, and the recording sheet is discharged to the main body discharge section. The discharge unit is adapted to be removable with respect to a side surface of the main body, and is connectable to a reverse transportation path to reverse front and back of the recording sheet when forming images on both sides of the recording sheet. The image forming device can selectively discharge the recording sheet to the main body discharge section or the discharge unit. Furthermore, the discharge unit includes a discharge tray, a swinging member, a discharge roller, and a rotation drive portion. The discharge tray accommodates the discharged recording sheet. The swinging member guides the recording sheet passed through the reverse transportation path to the discharge tray. The discharge roller discharges the recording sheet guided by the swinging member to the discharge tray. The rotation drive portion rotates the discharge roller and swings the swinging member.

In a preferred embodiment of the present invention, when the discharge unit is attached to the side surface of the main body and connected to the reverse transportation path, the swinging member is swung by the rotation drive portion to rotate the discharge roller, so that the swinging member guides the recording sheet passing the reverse transportation path to the discharge tray and accommodates the guided recording sheet in the discharge tray. Therefore, the recording sheet subjected to image forming on one side or both sides by the image forming section can be selectively discharged to one of the main body discharge section and the discharge unit based on the selection of the user and/or the attribute of the job, and the like. Moreover, since the rotation drive portion is used as the drive portion for the discharge roller and for the swinging member, a more simplified device configuration can be obtained. Furthermore, since the discharge unit is arranged on the side surface of the main body, the discharge unit is removable with respect to the main body regardless of whether the scanner device or the like is mounted on the image forming device.

The image forming device according to a preferred embodiment of the present invention preferably has a configuration such that, when the swinging member is swung, at least one portion of the swinging member enters inside and exits outside the reverse transportation path.

In a preferred embodiment of the present invention, at least one portion of the swinging member enters inside and exits outside the reverse transportation path. The discharge unit is connected to the reverse transportation path when at least one portion of the swinging member enters inside the reverse transportation path, and the discharge unit is shielded from the reverse transportation path when at least one portion of the swinging member exits outside the reverse transportation path.

The image forming device according to a preferred embodiment of the present invention preferably has a configuration such that the discharge unit includes a rotation intermittent member, and a rotation transmitting member. The rotation intermittent member transmits or shields the rotation of the rotation drive portion to the swinging member. The rotation transmitting member transmits the rotation of the rotation drive portion to the rotation intermittent member, and preferably has a disc shape. The rotation intermittent member includes a friction portion adapted to apply a predetermined friction resistance on one surface of the rotation transmitting member.

In a preferred embodiment of the present invention, since the friction portion of the rotation intermittent member applies a predetermined friction resistance on one surface of the rotation transmitting member, a frictional force is generated with respect to the rotation transmitting member. Therefore, as long as a force exceeding the frictional force is not applied, the friction portion (rotation intermittent member) can maintain the coupled state with the rotation transmitting member, and operates together with the rotation transmitting member.

The image forming device according to a preferred embodiment of the present invention preferably has a configuration such that the image forming device includes a control section and a transportation roller. The control section controls the discharge to the discharge unit. The transportation roller rotates in one direction or a reverse direction, and transports the recording sheet to the main body discharge section or the reverse transportation path. When discharging the recording sheet to the discharge unit, the control section reversely rotates the transportation roller and drives the rotation drive portion.

In a preferred embodiment of the present invention, when discharging the recording sheet to the discharge unit, the control section reversely rotates the transportation roller to transport the recording sheet to the reverse transportation path, and drives the rotation drive portion to drive the swinging member.

The image forming device according to a preferred embodiment of the present invention preferably has a configuration such that the rotation transmitting member is attached to a swinging shaft of the swinging member. The rotation intermittent member includes a hooking portion and a pushing portion. The hooking portion is hooked to the swinging shaft of the swinging member. The pushing portion pushes the friction portion.

The image forming device according to a preferred embodiment of the present invention preferably has a configuration such that a pushing portion slidably moves in the direction of the swinging shaft while maintaining contact with the hooking portion.

The image forming device according to a preferred embodiment of the present invention preferably has a configuration such that the main body includes a recording paper transportation path. The recording paper transportation path is a path in which the recording sheet fed from a paper feed cassette is transported to the main body discharge section through a fixing section and the image forming section. The image forming device includes a switch portion. The switch portion is arranged at a connecting portion of a path on a downstream side of the fixing section in the recording paper transportation path and the reverse transportation path. The switch portion includes a nail adapted to be rotatable. The nail guides the recording sheet to the reverse transportation path by operating.

The image forming device according to a preferred embodiment of the present invention preferably has a configuration such that the swinging member can swing in one direction or a reverse direction around a swinging shaft. The image forming device includes a first stopper. The first stopper limits the swinging to one side to be greater than or equal to a predetermined angle when the swinging member swings in one direction around the swinging shaft.

The image forming device according to a preferred embodiment of the present invention preferably has a configuration such that the image forming device includes a second stopper that limits the swing to the reverse direction to be greater than or equal to a predetermined angle when the swinging member swings in the reverse direction around the swinging shaft.

The image forming device according to a preferred embodiment of the present invention preferably has a configuration in which the main body includes a charge elimination member. The charge elimination member performs a charge elimination process on the recording sheet. When the recording sheet is discharged to the discharge unit, the charge elimination process of the discharged recording sheet is not carried out in the discharge unit, and is carried out by the charge elimination member arranged in the main body.

The image forming device according to a preferred embodiment of the present invention preferably has a configuration in which the image forming device can selectively discharge the recording sheet to the main body discharge section or the discharge unit after printing both sides of the recording sheet.

The image forming device according to a preferred embodiment of the present invention preferably has a configuration such that the image forming device selectively discharges the recording sheet to the main body discharge section or the discharge unit depending on printing related to copy or printing related to facsimile.

The image forming device according to a preferred embodiment of the present invention preferably has a configuration in which the image forming device selectively discharges the recording sheet to the main body discharge section or the discharge unit for every print job.

According to various preferred embodiments of the present invention, since the discharge to the discharge unit is carried out using the existing reverse transportation path without arranging an additional recording paper transportation path on the main body side for the removable discharge unit, which is not essential and the constant use thereof is not needed, whereby a manufacturing cost can be reduced and the device can be miniaturized. Application can be made to a multifunction peripheral in which the scanner device is arranged on the upper side of the main body discharge section since the discharge unit is attached to the side surface of the main body.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an explanatory view for explaining a configuration of a multifunction peripheral according to a preferred embodiment of the present invention.

FIG. 2 is an explanatory view schematically illustrating a transportation path of a document and a path of scanning light of the document in the multifunction peripheral according to a preferred embodiment of the present invention.

FIG. 3 is a perspective view of a state in which an external discharge unit is detached from a main body in the multifunction peripheral according to a preferred embodiment of the present invention.

FIG. 4 is a perspective view illustrating an internal configuration of a drive portion and a discharge roller portion in the multifunction peripheral according to a preferred embodiment of the present invention.

FIG. 5 is an enlarged configuration diagram of the main portions of the internal configuration of the drive portion in the multifunction peripheral according to a preferred embodiment of the present invention.

FIG. 6 is a cross-sectional view illustrating an internal configuration of a torque limiter in the multifunction peripheral according to a preferred embodiment of the present invention.

FIG. 7 is a schematic longitudinal cross-sectional view illustrating a configuration of main portions of a guiding portion in the multifunction peripheral according to a preferred embodiment of the present invention.

FIG. 8 is an explanatory view illustrating transportation of recording paper with an external discharge unit communicated to a switchback path in the multifunction peripheral according to a preferred embodiment of the present invention.

FIG. 9 is an explanatory view explaining transportation of the recording paper in double-sided printing with the external discharge unit attached to the main body.

### DETAILED DESCRIPTION OF THE PREFERRED EMBODIMENTS

An image forming device according to preferred embodiments of the present invention will be hereinafter described in detail based on the drawings for a case of a multifunction peripheral preferably having one or more of the functions of image scan, print, facsimile, copy, and the like, by way of example.

### First Preferred Embodiment

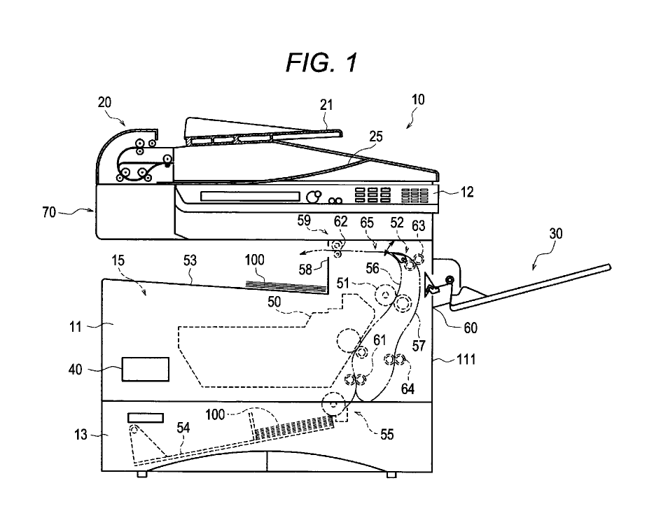

FIG. 1 is an explanatory view for explaining a configuration of main portions of a multifunction peripheral 10 according to a preferred embodiment of the present invention. As illustrated in FIG. 1, the multifunction peripheral 10 of the present preferred embodiment of the present invention includes a main body 11, an operation panel 12, a paper feed cassette 13, and a scanner device (RADF) capable of scanning both sides of a paper. The scanner device includes a transportation section 20 to sequentially transport one or more documents, and a scanning section 70, arranged below the transportation section 20, to scan the transported document.

The operation panel 12 is arranged on the outer side of the scanning section 70, and receives instructions related to the functions of image scan, print, copy, and the like of the multifunction peripheral 10 from the user. The operation panel 12 includes a display section including an LCD (Liquid Crystal Display) or EL (Electroluminescence), and is configured to display various items such as a discharging location, the number of copies, copy mode, and the like of the document in a form of a menu. Therefore, the user can perform an appropriate operation while looking at the menu displayed on the operation panel 12 to select the item of the menu, in which case the multifunction peripheral 10 receives the selection from the user through the operation panel 12.

The transportation section 20 is arranged above the operation panel 12, and an image forming device 15 is incorporated in the main body 11. Furthermore, a transmission/reception section (not illustrated) to transmit image data through a communication line is arranged in the main body 11, so that facsimile communication can be realized by the transmission/reception section. The paper feed cassette 13 is arranged below the main body 11, and is configured to sequentially feed recording paper 100 to the image forming device 15.

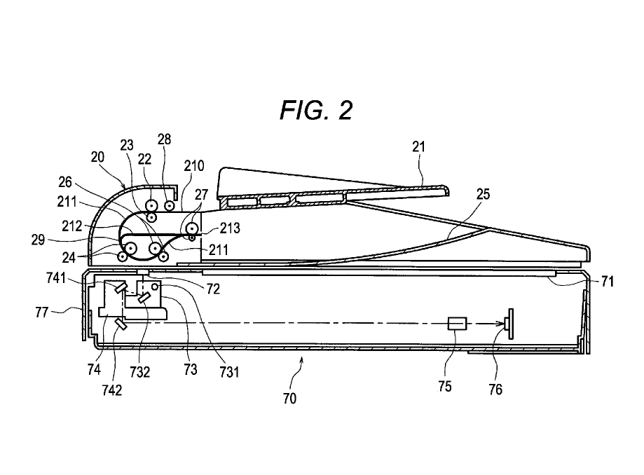

FIG. 2 is an explanatory view schematically illustrating a transportation path of the document and a path of scanning light of the document in the multifunction peripheral according to the present preferred embodiment of the present invention.

A document tray 21, having a width corresponding to the maximum horizontal width of the document, so as to mount the document in a face-up manner is arranged at an upper portion of the center of the transportation section 20 in an inclined manner so as to be slightly lowered from one side to the other side. A first transportation path 211 defined by a guide having a cross-section in front view that has a hook shape is arranged at the other side of the transportation section 20, where the document fed from the document tray 21 to the first transportation path 211 through a feeding path 210 is transported towards a paper exit port 213 arranged below the other end of the document tray 21.

A second transportation path 212 is arranged towards the paper exit port 213 from a branched portion 29 provided in the middle of the first transportation path 211, where switchback is made from the paper exit port 213 side towards the branched portion 29 so that the document transported through the second transportation path 212 is returned to the first transportation path 211 and the front and back sides of the document are reversed. The first transportation path 211 and the second transportation path 212 are merged at a position on the other side of the paper exit port 213. An output tray 25 to sequentially stack and mount the documents discharged from the paper exit port 213 in a face-down manner is arranged below the document tray 21 so as to be substantially parallel to the document tray 21.

A pickup roller 28 to feed the documents towards the first transportation path 211 one at a time is arranged above the other end of the feeding path 210. A separation roller 22 and a retard roller 23 to send the documents fed from the feeding path 210 to the downstream side while separating are arranged at positions in the first transportation path 211 where the transportation of the document is started. For example, if a plurality of documents is fed to the first transportation path 211 at one time, the retard roller 23 is rotated in the reverse direction to prevent multi-feeding of the documents. A mere pushing plate may be arranged facing the separation roller 22 instead of the retard roller 23 to prevent multi-feeding of the documents.

The lowermost portion of the portion curved downward in the first transportation path 211 faces a contact glass 72 arranged on the other side of an upper surface of a case 77 of the scanning section 70. A pair of resist rollers 24 to correct the skew of the document transported through the first transportation path 211 is arranged on the lower side of the branched portion 29. A pair of paper discharge rollers 27 to discharge the document from the paper exit port 213 is arranged between the merged portion of the first transportation path 211 and the second transportation path 212 and the paper exit port 213. A pair of post-scan rollers 26 to transport the document that passed through a scan position (immediately above contact glass 72) towards a downstream side is arranged on the lower side of the paper discharge roller 27.

The scanning section 70 includes the case 77 including a platen glass 71 of a width substantially the same as the width of the document tray 21 on the upper surface thereof. The platen glass 71 is provided to flatly place the document when the document that cannot be transported such as a book document is scanned from the lower side. A first carriage 73 including a light source 731 to radiate the document diagonally upward, and a mirror 732 to reflect the scanning light reflected to the lower side from the document to a diagonally upper side of the other side is arranged in the case 77. A second carriage 74 including a mirror 741 to reflect the scanning light reflected by the mirror 732 to the lower side and a mirror 742 to reflect the scanning light reflected by the mirror 741 to one side is also arranged in the case 77. The scanning light reflected by the mirror 742 is gathered by a light gathering lens 75, and is guided to a photoelectric converter 76 arranged on one side of the case 77.

The first carriage 73 and the second carriage 74 are movable in a horizontal direction to scan the document flatly placed on the platen glass 71. When scanning the document transported through the transportation section 20, the first carriage 73 and the second carriage 74 are stationary at a location immediately below the contact glass 72. The scanning light radiated towards the vertically lower side through the contact glass 72 from the document passing the scan position is reflected by the mirrors 732, 741, 742 in this order to enter the photoelectric converter 76.

As described above, the image forming device 15 is arranged inside the main body 11. As illustrated in FIG. 1, the image forming device 15 includes an image forming section 50, a fixing section 51, and a switchback mechanism 59. A removable external discharge unit 30 (discharge unit) is attached to the outer side of the main body 11.

The paper feed cassette 13 is arranged below the main body 11 and is arranged at the front side of the device (near side in plane of drawing of FIG. 1) so that it can be pulled out. The image forming section 50, the fixing section 51, the switchback mechanism 59, and the discharge section 53 (main body discharge section) are arranged above the paper feed cassette 13.

The image forming device 15 includes a control section 40 to control the image forming section 50, rollers of each section, to be described later, and the switchback mechanism 59. The switchback mechanism 59 includes, as a main configuration, a recording paper discharge roller 62 (transportation roller)to discharge the recording paper 100 to the discharge section 53 through a discharge port 58, a switch portion 52 to carry out guidance in the recording paper transportation, a recording paper transportation path 56, and a switchback path 57.

The recording paper transportation path 56 is a recording paper transportation path to transport the recording paper 100 picked up from the paper feed cassette 13 to the tray-shaped discharge section 53 through the image forming section 50. The recording paper transportation path 56 connects the paper feed cassette 13 and the discharge section 53 so as to have a substantially C-shape in front view illustrated in FIG. 1.

The switchback path 57 is a recording paper transportation path that enables double-sided printing, that is, the transportation path of the recording paper at the time of the double-sided printing. Both ends of the switchback path 57 are configured to communicate with the recording paper transportation path 56.

Specifically, one end of the switchback path 57 is communicated to the recording paper transportation path 56 on the downstream side of the fixing section 51, and the switch portion 52 is arranged near the communicating portion. The other end of the switchback path 57 is communicated to the recording paper transportation path 56 at the area on the downstream side of a paper feed section 55 and on the upstream side of the image forming section 50. The switchback path 57 is located in the vicinity of a side wall 111 facing the discharge port 58.

As illustrated in FIG. 1, the switchback path 57 includes a U-turn shaped path in combination with one portion of the recording paper transportation path 56. The recording paper that once passed the image forming section 50 along the recording paper transportation path 56 is transported to the switchback path 57 to have the front and back reversed, and is again guided to the image forming section 50 when the recording paper discharge roller 62 is reversely rotated at the time of the switchback by the control section 40, whereby double-sided printing by a single image forming section 50 is realized.

The configuration of the image forming device 15 will now be described. First, for the sake of convenience of explanation, the configuration of each section arranged on the recording paper transportation path 56 will be described in order from the upstream side to the downstream side.

A flapper 54 to stack sheets of the recording paper 100 is arranged in a swinging manner at the bottom of the paper feed cassette 13. The flapper 54 is biased upward by a spring (not illustrated). The paper feed section 55 preferably configured by a paper feed roller, a paper feed pad, and the like is arranged above the flapper 54. The paper feed roller of the paper feed section 55 is adapted to make contact with the uppermost recording paper 100 stacked on the flapper 54.

A pair of recording paper transportation rollers 61 is arranged on the downstream side of the paper feed cassette 13. The recording paper transportation roller 61 is configured to nip the recording paper 100 and send the recording paper 100 to the image forming section 50 on the further downstream side along the recording paper transportation path 56.

The recording paper transportation path 56 is arranged to curve in a C-shape, as described above, where the image forming section 50 is arranged on the inner peripheral side thereof to face the recording paper transportation path 56. The image forming section 50 includes a photosensitive drum, a charger, an exposure head, a developer, a transfer roller, and the like. The image forming section 50 transfers (forms) a toner image with respect to the recording paper 100 transported by the recording paper transportation roller 61. The recording paper 100 having the toner image formed in the image forming section 50 is sent along the recording paper transportation path 56 to the fixing section 51 on the further downstream side.

The fixing section 51 includes a rotatably driven heat roller, and a press roller arranged facing the heat roller. The fixing section 51 is configured to melt the toner of the toner image transferred to the recording paper 100 in the image forming section 50 by the heat of the high temperature heat roller and the pressure of the press roller to fix the same on the recording paper 100.

As described above, the switch portion 52 including a nail or the like configured to be rotatable is arranged at the communicating portion of the recording paper transportation path 56 and the switchback path 57 on the downstream side of the fixing section 51.

The recording paper 100 can be guided to the switchback path 57 by the rotating operation of the nail of the switch portion 52. In the recording paper transportation path 56, a switchback sensor 65 is arranged at a position on a slightly downstream side of the communicating portion with the switchback path 57.

The recording paper discharge roller 62 is arranged on a further downstream side of the switchback sensor 65. The recording paper discharge roller 62 is configured to switch the rotating direction to the forward direction (clockwise direction in FIG. 1) or the reverse direction (counterclockwise direction in FIG. 1).

An end of the recording paper transportation path 56 is connected to the discharge port 58 and the discharge section 53 at the further downstream side of the recording paper discharge roller 62. The recording paper 100 having an image formed in the image forming section 50 is passed through the curved recording paper transportation path 56 to be discharged to the discharge section 53 so that the surface including the relevant image is facing downward (face-down paper discharge).

Recording paper transportation rollers 63, 64 are arranged on the switchback path 57, so that the recording paper 100 sent to the switchback path 57 can be transported towards an area on the upstream side of the recording paper transportation roller 61.

For example, when single-sided printing is carried out, the image forming device 15 operates in the following manner. In other words, when the paper feed section 55 is driven with the start of printing, the uppermost recording paper 100 set in the paper feed cassette 13 is picked up by the paper feed roller, and sent out towards the recording paper transportation path 56.

The recording paper 100 is sent to the downstream side along the recording paper transportation path 56, and is formed with a desired toner image when passing the image forming section 50. Thereafter, the recording paper 100 is passed through the fixing section 51 to fix the toner image on the recording paper 100. Subsequently, the recording paper 100 is discharged to the discharge section 53 through the discharge port 58 with the surface formed with the image facing down by the recording paper discharge roller 62 rotatably driven in the forward direction.

On the other hand, when double-sided printing is carried out, one sheet of the recording paper 100 is picked up from the paper feed cassette 13, and passed through the image forming section 50 along the recording paper transportation path 56 to be formed with the toner image. The recording paper 100 having the toner image formed on one surface is passed through the fixing section 51, and transported further to the downstream side along the recording paper transportation path 56.

The recording paper 100 is then transported in a nipped state by the recording paper discharge roller 62, and the rear end of the recording paper 100 eventually passes the switchback sensor 65. The switchback sensor 65 that detected the passing of the rear end of the recording paper 100 sends a signal indicating the detection to the control section 40.

The control section 40 that received the signal drives the recording paper discharge roller 62 in the reverse direction, and operates the switch portion 52 at an appropriate timing to guide the recording paper 100 to the switchback path 57. The recording paper 100 is thereby sent to the switchback path 57.

In the switchback path 57, the recording paper 100 is transported to the downstream side by the drive of the recording paper transportation rollers 63, 64, and is again introduced to the recording paper transportation path 56. Furthermore, the recording paper 100 is transported to the downstream side by the recording paper transportation roller 61, and again passed through the image forming section 50.

As the recording paper 100 is reversed when passing the switchback path 57, the surface on the side opposite to the surface on which the toner image was formed when passed through the image forming section 50 the previous time now faces the image forming section 50.

The recording paper 100 with the toner image formed on the other surface is passed through the fixing section 51, and further transported to the downstream side along the recording paper transportation path 56. Meanwhile, the recording paper discharge roller 62 is switched by the control section 40 to again rotate in the forward direction at an appropriate timing after sending the recording paper 100 to the switchback path 57 by the rotation in the reverse direction, as described above. Therefore, the recording paper 100, in which the double-sided printing has been completed, is discharged to the discharge section 53 through the discharge port 58 by the recording paper discharge roller 62.

A second discharge port 60 is arranged on the side wall 111 on the opposite side of the discharge port 58 with the recording paper transportation path 56 and the switchback path 57 located therebetween. More specifically, the switchback path 57 is arranged to be adjacent to the second discharge port 60, and the switchback path 57 communicates to the outer side of the main body 11 through the second discharge port 60.

The external discharge unit 30 is attached to the second discharge port 60. Specifically, the external discharge unit 30 is configured to be communicable at the middle of the switchback path 57, and if the external discharge unit 30 is communicated to the switchback path 57, the recording paper 100 passing the switchback path 57 is discharged to the external discharge unit 30 through the second discharge port 60. In other words, in the multifunction peripheral 10 of the present preferred embodiment of the present invention, the recording paper 100 is selectively discharged to one of the discharge section 53 and the external discharge unit 30.

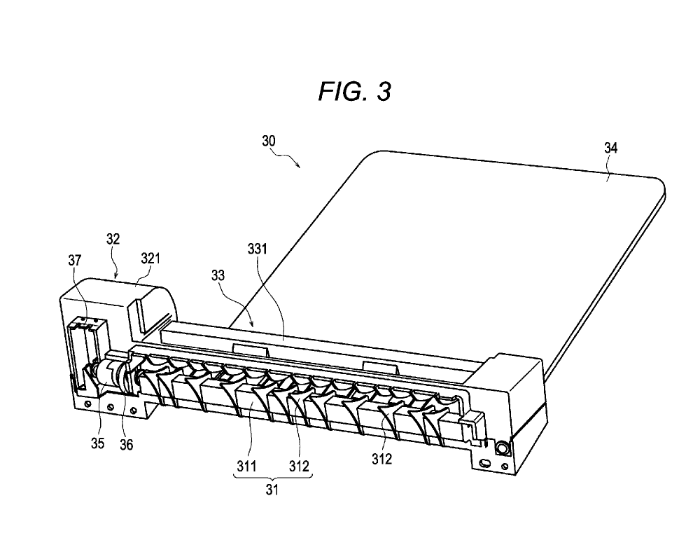

FIG. 3 is a perspective view of a state in which the external discharge unit 30 is detached from the main body 11 in the multifunction peripheral 10 of the present preferred embodiment of the present invention.

The external discharge unit 30 includes a discharge tray 34 to accommodate the recording paper to be discharged, a guiding portion 31 (swinging member) to guide the recording paper passing the switchback path 57 to the external discharge unit 30, and a discharge roller portion 33 to transport the recording paper 100 guided by the guiding portion 31 to the discharge tray 34.

The external discharge unit 30 further includes a drive portion 32 (rotation drive portion) with a motor to rotate a discharge roller 132, to be described later, a torque limiter 35 (rotation intermittent member) to transmit or shield the rotation of the motor of the drive portion 32 to the guiding portion 31, a transmission gear 36 (rotation transmitting member) to transmit the rotation of the motor of the drive portion 32 to the torque limiter 35, and an attachment portion 37 to attach the external discharge unit 30 to the main body 11 (second discharge port 60).

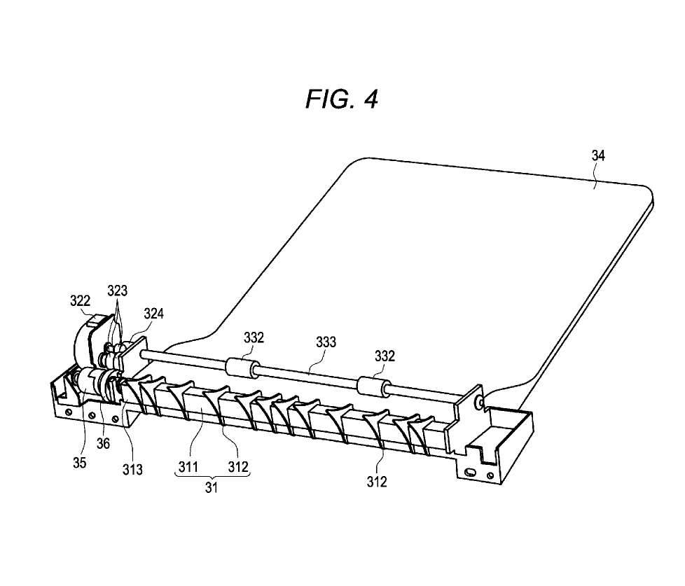

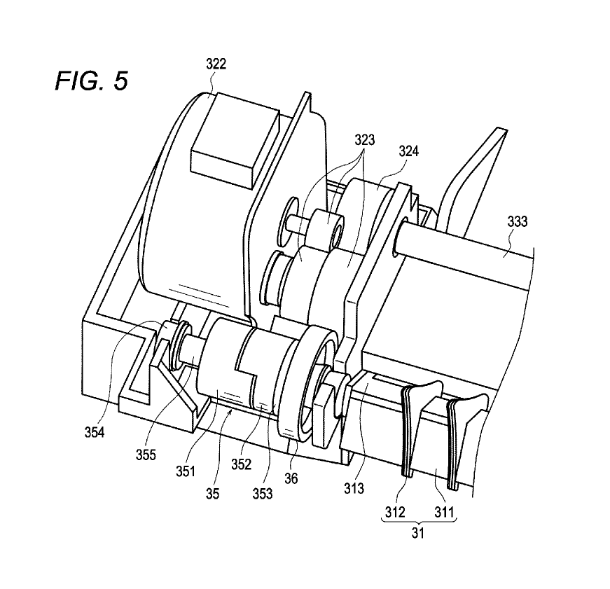

FIG. 4 is a perspective view illustrating an internal configuration of the drive portion 32 and the discharge roller portion 33 in the multifunction peripheral 10 of the present preferred embodiment of the present invention, and FIG. 5 is an enlarged configuration diagram of the main portions of the internal configuration of the drive portion 32 in the multifunction peripheral 10 of the present preferred embodiment of the present invention.

The discharge tray 34 preferably has a square plate shape, and has sheets of recording paper guided and discharged by the guiding portion 31 stacked thereon.

The discharge roller portion 33 includes a cover 331, two rollers 332 (discharge roller) and a rotation shaft 333. The rotation shaft 333 has a circular column shape, and is coupled to a gear 324 of the drive portion 32, to be described later, to be pivotally supported in a swingable manner.

The roller 332 is preferably made of rubber, for example, and has a cylindrical shape. Two rollers 332 are concentrically aligned, and are externally fitted to the rotation shaft 333. When the rotation shaft 333 is rotated by the rotation of the motor of the drive portion 32 transmitted through the gear 324, the roller 332 is also rotated so that the recording paper 100 guided by the guiding portion 31 can be transported to the discharge tray 34.

The drive portion 32 includes a drive portion cover 321, a motor 322, a rotation transmitting mechanism 323 to transmit the rotation of the motor 322 to the transmission gear 36, and a gear 324 to transmit the rotation of the motor 322 to the discharge roller portion 33.

The rotation transmitting mechanism 323 includes a plurality of gears including a motor gear fitted and attached to the output end of the motor 322. The plurality of gears are geared to each other, and transmit the rotation of the motor 322 to the transmission gear 36.

Furthermore, the motor gear fitted and attached to the output end of the motor 322 is also geared with the gear 324, where the discharge roller portion 33 coupled through the gear 324 and the guiding portion 31 coupled through the transmission gear 36 cooperatively operate when the motor 322 is rotated.

The transmission gear 36 is a disc-shaped gear, and is geared with the gear of the rotation transmitting mechanism 323. Therefore, when the motor 322 is rotated, the rotation of the motor 322 is transmitted through the rotation transmitting mechanism 323 and the transmission gear 36 is also rotated. The transmission gear 36 transmits the relevant rotation to the torque limiter 35.

The torque limiter 35 is adjacent to the transmission gear 36 and has a circular column shape. The torque limiter 35 is arranged such that the center axis is coaxial with the rotation shaft of the transmission gear 36. Furthermore, the torque limiter 35 is pivotally supported in a swingable manner, and is rotated in the forward direction or the reverse direction by the rotation of the transmission gear 36.

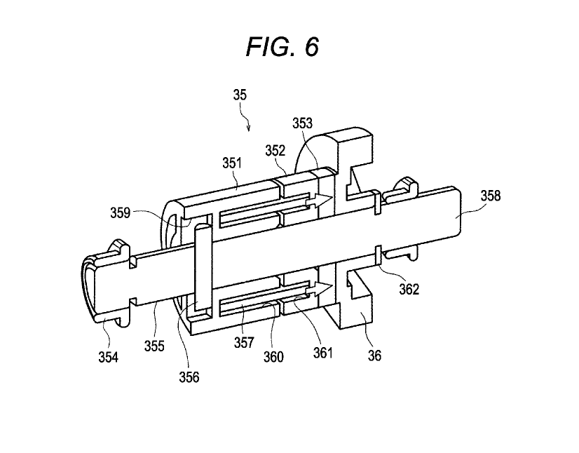

Moreover, the torque limiter 35 includes a rotation shaft 355, a shaft supporting portion 354 to support one end of the rotation shaft 355 in a rotatable manner, a hooking portion 351 hooked on the rotation shaft 355 using a pin 356, to be described later, a pushing portion 352 to push a felt portion 353 (friction portion), to be described later, and the felt portion 353 which is interposed between the pushing portion 352 and the transmission gear 36 and which makes contact with the side surface of the transmission gear 36. FIG. 6 is a cross-sectional view illustrating an internal configuration of the torque limiter 35 in the multifunction peripheral 10 of the present preferred embodiment of the present invention.

The hooking portion 351 and the pushing portion 352 preferably have a circular column shape with the same diameter with respect to each other, where the felt portion 353 preferably has a disc shape of the same diameter as the hooking portion 351 and the pushing portion 352. The hooking portion 351, the pushing portion 352, and the felt portion 353 are arranged side by side in the relevant order, and define one circular column shaped structure as a whole. The hooking portion 351, the pushing portion 352, and the felt portion 353 are penetrated by the rotation shaft 355 in the side-by-side direction.

The hooking portion 351 and the pushing portion 352 respectively includes a corresponding cutout on the opposing surface of each other, and are configured to combine with each other by the engagement of each cutout. Therefore, the pushing portion 352 can be moved only in the direction in which the engagement with the hooking portion 351 can be maintained.

In other words, the pushing portion 352 can slidably move in the axial direction of the rotation shaft 355 alone while maintaining the engagement with the hooking portion 351, but cannot independently move around the axis of the rotation shaft 355. Since the hooking portion 351 and the pushing portion 352 are engaged, when one of the hooking portion 351 and the pushing portion 352 is rotated, the other one is also rotated.

The hooking portion 351 penetrates the rotation shaft 355 in the radial direction, and hooked to the rotation shaft 355 by a pin 356 fixed and attached to the rotation shaft 355. Specifically, a recess 359 having a shape corresponding to that of the pin 356 is formed on the inner side of the hooking portion 351, where the hooking portion 351 is hooked to the rotation shaft 355 when the recess 359 and the pin 356 are engaged.

Furthermore, the hooking portion 351 includes a groove 360 arranged in the axial direction where one portion of the compressed coil spring 357 is inserted to the groove 360. On the other hand, the pushing portion 352 includes a groove 361 at the position corresponding to the groove 360, and the other portion of the compressed coil spring 357 is inserted to the groove 361.

In other words, the pushing portion 352 slidably moves along the axial direction of the rotation shaft 355 to push the felt portion 353 in the direction of the transmission gear 36 (direction of arrow in FIG. 6) while maintaining the engagement with the hooking portion 351 by the spring force of the compressed coil spring 357. Therefore, the felt portion 353 defining a disc shape is pushed against the side surface of the transmission gear 36.

The felt portion 353 may be made from a felt material having a predetermined coefficient of friction, for example, where one surface of the felt portion 353 makes contact with one surface of the transmission gear 36 by being interposed between the pushing portion 352 and the transmission gear 36. A predetermined friction resistance is applied to the transmission gear 36 since the felt portion 353 has a predetermined coefficient of friction.

Furthermore, since an E ring 362 is externally fitted to the rotation shaft 355 at the other surface side of the transmission gear 36, the transmission gear 36 cannot slidably move in the axial direction of the rotation shaft 355 and thus come into pressure contact with the felt portion 353. Therefore, the felt portion 353 couples with the transmission gear 36 in a limited manner by the frictional force generated between the felt portion 353 and the transmission gear 36.

For example, when the transmission gear 36 is rotated, the felt portion 353 rotates together with the transmission gear 36 by the friction resistance. On the other hand, when a force exceeding the friction resistance is applied in the direction of stopping the rotation of the felt portion 353, the transmission gear 36 may rotate but the felt portion 353 no longer rotates.

A case in which the felt portion 353 is a felt material has been described by way of example in the present preferred embodiment, but the present invention is not limited thereto, and the felt portion 353 merely needs to be a material having a coefficient of friction to an extent capable of rotating together with the rotation of the transmission gear 36.

The guiding portion 31 is attached to the other end 358 of the rotation shaft 355. The other end 358 of the rotation shaft 355 is subjected to a D cut, and is fitted with one end 313 of an L-shaped cross-sectional portion 311, to be described later. In other words, the guiding portion 31 also rotates when the rotation shaft 355 is rotated.

The guiding portion 31 includes a swinging portion 312 (one portion) that performs a swinging movement by the forward/reverse rotation of the rotation shaft 355, and the L-shaped cross-sectional portion 311 including a plurality of swinging portions 312 and having an L-shape when viewed in the longitudinal section.

The swinging portion 312 preferably has a plate-shaped fin configuration, where the plurality of swinging portions 312 are arranged side by side so as to face each other with the distal ends thereof facing the outer side. More specifically, when the external discharge unit 30 is attached to the main body 11, the swinging portion 312 is arranged so as to be directed to the inner side of the main body 11 through the second discharge port 60. The L-shaped cross-sectional portion 311 is connected to the base of the plurality of swinging portions 312.

The L-shaped cross-sectional portion 311 preferably has an L beam shape, and is arranged such that the longitudinal direction becomes the extending direction of the rotation shaft 355 of the torque limiter 35. The L-shaped cross-sectional portion 311 is arranged such that the inner side is facing downward.

A recess (not illustrated) corresponding to the D cut of the other end 358 of the rotation shaft 355 is located at one end 313 of the L-shaped cross-sectional portion 311, and is fitted with the other end 358 of the rotation shaft 355. The other end of the L-shaped cross-sectional portion 311 is pivotally supported in a swingable manner, and the swinging portion 312 is also rotated (swung) with the forward/reverse rotation of the rotation shaft 355.

In other words, in the multifunction peripheral 10 of the present preferred embodiment of the present invention, the rotation of the motor 322 of the drive portion 32 is transmitted in the order of the rotation transmitting mechanism 323, the transmission gear 36, the felt portion 353, the pushing portion 352, the hooking portion 351, the rotation shaft 355, and the guiding portion 31, where the swinging portion 312 is swung by the forward/reverse rotation of the motor 322 of the drive portion 32.

The swing of the swinging portion 312 of the guiding portion 31 will be specifically described below.

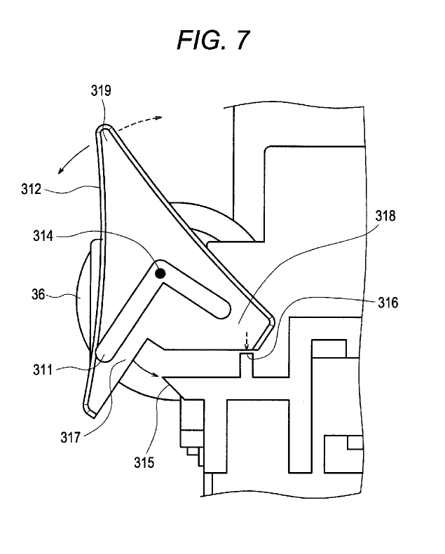

FIG. 7 is a schematic longitudinal sectional view illustrating the configuration of the main portions of the guiding portion 31 in the multifunction peripheral 10 of the present preferred embodiment of the present invention. A forward direction stopper 315 and a reverse direction stopper 316 are arranged below the base of the swinging portion 312.

The forward direction stopper 315 limits the rotation to be greater than or equal to a predetermined angle in the forward direction when the swinging portion 312 is rotated in the forward direction (indicated with solid line arrow in FIG. 7) around the center axis 314. The reverse direction stopper 316 limits the rotation of greater than or equal to a predetermined angle in the reverse direction when the swinging portion 312 is rotated in the reverse direction (indicated with broken line arrow in FIG. 7).

For example, when the motor 322 is rotated in the forward direction, such rotation is transmitted to the guiding portion 31 as described above, whereby the swinging portion 312 is rotated in the forward direction. However, when rotated by a predetermined angle in the forward direction, the swinging portion 312 cannot further rotate in the forward direction since one end 317 of the base comes into contact with the forward direction stopper 315.

In such a case, a force exceeding the friction resistance is applied on the felt portion 353 in the direction of stopping the rotation of the felt portion 353, and hence the felt portion 353 is no longer rotated even if the transmission gear 36 continues to be rotated. In this case, the swinging portion 312 stops with a distal end 319 projecting out to the outer side (inner side of main body 11 when external discharge unit 30 is attached to main body 11).

On the other hand, when the motor 322 is rotated in the reverse direction, such rotation is transmitted to the guiding portion 31 as described above, whereby the swinging portion 312 is rotated in the reverse direction. However, when rotated by a predetermined angle in the reverse direction, the swinging portion 312 cannot further rotate in the reverse direction since the other end 318 of the base comes into contact with the reverse direction stopper 316.

In such a case, a force exceeding the friction resistance is applied on the felt portion 353 in the direction of stopping the rotation of the felt portion 353, and hence the felt portion 353 is no longer rotated even if the transmission gear 36 continues to be rotated. In this case, the swinging portion 312 stops with the distal end 319 facing upward.

Therefore, when the motor 322 of the drive portion 32 is rotated in the forward direction or the reverse direction, the swinging portion 312 is rotated and swung in the forward direction or the reverse direction around the center axis 314 within a limited angle.

Furthermore, as the switchback path 57 is adjacent to the second discharge port 60 and is configured to communicate with the outer side of the main body 11 through the second discharge port 60, as described above, the swing of the swinging portion 312 is carried out in a range across the switchback path 57 when the external discharge unit 30 is attached to the second discharge port 60.

In other words, when the swinging portion 312 is rotated in the forward direction and the one end 317 of the base is in contact with the forward direction stopper 315, the swinging portion 312 stops with the distal end 319 of the swinging portion 312 on the inner side of the main body 11 and is projected out into the switchback path 57. The external discharge unit 30 is thereby communicated to the switchback path 57.

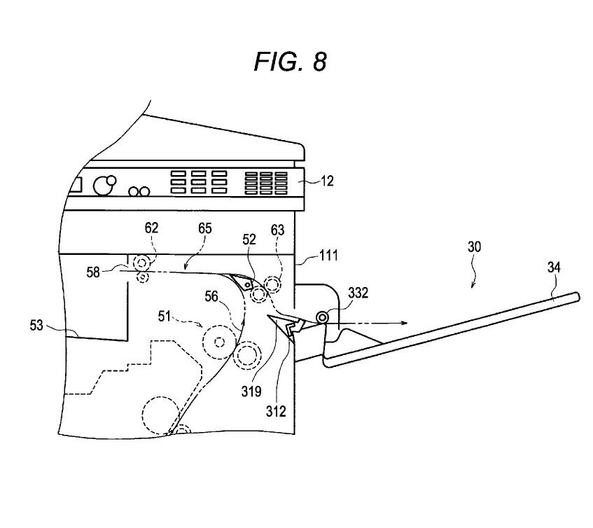

FIG. 8 is an explanatory view illustrating transportation of recording paper with the external discharge unit 30 communicated to the switchback path 57 in the multifunction peripheral 10 of the present preferred embodiment of the present invention. For the sake of convenience of explanation, a case of discharging the recording paper to the external discharge unit 30 in response to the instruction from the user will be described by way of example.

For example, when the multifunction peripheral 10 receives the instruction from the user through the operation panel 12, the control section 40 transports the image-formed recording paper transported to the recording paper discharge roller 62 through the recording paper transportation path 56 to the switchback path 57.

Specifically, when the rear end of the recording paper passes the switchback sensor 65, the switchback sensor 65 that detected the passing of the rear end of the recording paper sends a signal indicating the detection to the control section 40. In such a case, the recording paper passes the discharge port 58, and the rear end is sandwiched by the recording paper discharge roller 62. The discharge port 58 includes a charge elimination member (not illustrated), so that the recording paper is subjected to the charge elimination process when passing the discharge port 58.

The control section 40 that received the signal from the switchback sensor 65 drives the recording paper discharge roller 62 in the reverse direction and appropriately operates the switch portion 52 to guide the recording paper to the switchback path 57, thus transporting the recording paper to the switchback path 57.

Furthermore, the control section 40 turns ON the motor 322 of the drive portion 32 and rotates the motor 322 in the forward direction. When the motor 322 is rotated in the forward direction, the swinging portion 312 of the guiding portion 31 is also rotated by a predetermined angle in the forward direction and then stopped with the distal end 319 projected out into the switchback path 57. At this time, the roller 332 of the discharge roller portion 33 also starts to rotate.

The recording paper transported to the switchback path 57 is thereafter transported to the downstream side along the switchback path 57 by the recording paper transportation roller 63. However, as illustrated in FIG. 8, the swinging portion 312 is stopped with the distal end 319 of the swinging portion 312 of the guiding portion 31 projected out into the switchback path 57 at the downstream side of the recording paper transportation roller 63, and thus the recording paper that passed the recording paper transportation roller 63 is guided by the swinging portion 312 and transported towards the external discharge unit 30 through the second discharge port 60. The recording paper guided by the swinging portion 312 of the guiding portion 31 is discharged to the discharge tray 34 (direction of chain double dashed line arrow in FIG. 8) by the rotation of the roller 332 of the discharge roller portion 33. In this case, the face-down paper discharge is maintained, similarly to the case of the discharge to the discharge section 53.

On the other hand, if no instruction is made from the user, the image-formed recording paper is set to be discharged to the discharge section 53 arranged in the main body 11 of the multifunction peripheral 10 as a default. Therefore, when the user appropriately operates the operation panel 12, the image-formed recording paper can be selectively discharged to one of the discharge section 53 on the main body 11 side and the external discharge unit 30. The charge elimination member is not required to be separately arranged in the external discharge unit 30 since the charge elimination process is already carried out by the charge elimination member arranged in the recording paper discharge roller 62.

A drive source for the guiding portion 31 is not required to be separately arranged and the structure of the external discharge unit 30 can be simplified since the swinging portion 312 of the guiding portion 31 is driven (swung) using the motor 322 of the drive portion 32 for rotating the roller 332.

For example, consider a case of performing the double-sided printing with the external discharge unit 30 attached to the main body 11. In this case, the control section 40 rotates the motor 322 of the drive portion 32 in the reverse direction so that the external discharge unit 30 is shielded from the switchback path 57.

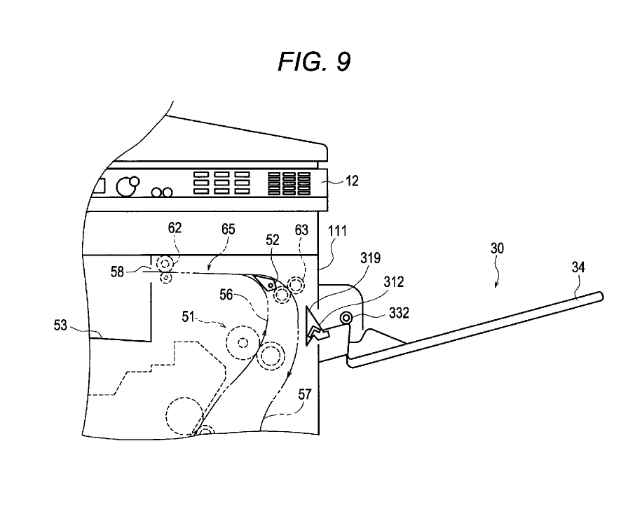

FIG. 9 is an explanatory view describing the transportation of the recording paper in the double-sided printing with the external discharge unit 30 attached to the main body 11.

For example, when the multifunction peripheral 10 receives a double-sided printing instruction from the user through the operation panel 12, the control section 40 transports the recording paper to the switchback path 57 to again perform image formation on the back surface of the recording paper, on which front surface the image is already formed, transported to the recording paper discharge roller 62 through the recording paper transportation path 56.

Specifically, the switchback sensor 65, which detected the passing of the rear end of the recording paper when the rear end of the recording paper passes the switchback sensor 65, sends a signal indicating the detection to the control section 40. The control section 40 that received the relevant signal drives the recording paper discharge roller 62 in the reverse direction and appropriately operates the switching portion 52 so as to guide the recording paper 100 to the switchback path 57, whereby the recording paper 100 is transported to the switchback path 57.

Furthermore, the control section 40 rotates the motor 322 of the drive portion 32 in the reverse direction. When the motor 322 is rotated in the reverse direction, the swinging portion 312 of the guiding portion 31 is also rotated by a predetermined angle in the reverse direction, and thereafter, stopped with the distal end 319 of the swinging portion 312 moved away from the switchback path 57 and facing upward.

The recording paper transported to the switchback path 57 is thereafter transported to the downstream side along the switchback path 57 by the recording paper transportation roller 63. In this case, the swinging portion 312 of the guiding portion 31 is stopped with the distal end 319 facing upward, and the guiding portion 31 is shielded from the switchback path 57, and hence the recording paper that passed the recording paper transportation roller 63 is not guided towards the external discharge unit 30 but is transported to the further downstream side of the switchback path 57 (direction of chain double dashed arrow in FIG. 9) and has the front and the back reversed. After the front and the back is reversed and the double-sided printing is carried out, the relevant recording paper is discharged to one of the discharge section 53 on the main body 11 side and the external discharge unit 30.

According to the above configuration, the multifunction peripheral 10 of the present preferred embodiment of the present invention can discharge to the external discharge unit 30 using the existing recording paper transportation path without separately arranging the recording paper transportation path. In other words, a separate recording paper transportation path is not required to be arranged on the main body 11 side for the external discharge unit 30, which constant use is not needed, and furthermore, the manufacturing cost can be reduced and the device can be miniaturized since the existing recording paper transportation path is used. Moreover, application can be easily made to a variety of ready-made products.

### Second Preferred Embodiment

In the first preferred embodiment described above, a case of discharging the image-formed recording paper to one of the discharge section 53 on the main body 11 side and the external discharge unit 30 according to the selection of the user has been described by way of example, but the present invention is not limited thereto. For example, the recording paper may be discharged depending on printing related to copy or printing related to facsimile, or may be discharged for every print job.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image forming device comprising:
an image forming section arranged to form an image on one side or both sides of a recording sheet;
a main body, in which the image forming section is arranged;
a main body discharge section arranged in the main body, and to which the recording sheet is discharged; and
a discharge unit arranged to be removable with respect to a side surface of the main body, and connectable to a reverse transportation path to reverse front and back of the recording sheet when forming images on both sides of the recording sheet; wherein
the recording sheet is selectively discharged to the main body discharge section or the discharge unit; and
the discharge unit includes:
a discharge tray arranged to accommodate the discharged recording sheet;
a swinging member arranged to guide the recording sheet passed through the reverse transportation path to the discharge tray;
a discharge roller arranged to discharge the recording sheet guided by the swinging member to the discharge tray; and
a rotation drive portion arranged to rotate the discharge roller and swing the swinging member.

2. The image forming device according to claim 1, wherein when the swinging member is swung, at least one portion of the swinging member enters inside and exits outside the reverse transportation path.

3. The image forming device according to claim 1, wherein the discharge unit includes:
a rotation intermittent member arranged to transmit or shielding rotation of the rotation drive portion to the swinging member; and
a rotation transmitting member having a disc shape and arranged to transmit the rotation of the rotation drive portion to the rotation intermittent member; and
the rotation intermittent member includes a friction portion arranged to apply a predetermined friction resistance on one surface of the rotation transmitting member.

4. The image forming device according to claim 1, further comprising:
a control section arranged and programmed to control the discharge to the discharge unit; and
a transportation roller that rotates in one direction or a reverse direction to transport the recording sheet to the main body discharge section or the reverse transportation path; wherein
when discharging the recording sheet to the discharge unit, the control section reversely rotates the transportation roller and drives the rotation drive portion.

5. The image forming device according to claim 3, wherein the rotation transmitting member is attached to a swinging shaft of the swinging member; and
the rotation intermittent member includes:
a hooking portion hooked to the swinging shaft of the swinging member; and
a pushing portion arranged to push the friction portion.

6. The image forming device according to claim 5, wherein the pushing portion slidably moves in a direction of the swinging shaft while maintaining contact with the hooking portion.

7. The image forming device according to claim 1, wherein the main body includes a recording paper transportation path as a path in which the recording sheet fed from a paper feed cassette is transported to the main body discharge section through a fixing section and the image forming section;
the image forming device includes a switch portion arranged at a connecting portion of a path on a downstream side of the fixing section in the recording paper transportation path and the reverse transportation path;
the switch portion includes a nail arranged to be rotatable; and
the nail guides the recording sheet to the reverse transportation path.

8. The image forming device according to claim 1, wherein the swinging member swings in one direction or a reverse direction around a swinging shaft; and
the image forming device further includes a first stopper arranged to limit a swing of greater than or equal to a predetermined angle to one direction when the swinging member swings in the one direction around the swinging shaft.

9. The image forming device according to claim 6, further comprising a second stopper arranged to limit a swing of greater than or equal to a predetermined angle to a reverse direction when the swinging member swings in the reverse direction around the swinging shaft.

10. The image forming device according to claim 1, wherein the main body includes a charge elimination member arranged to perform a charge elimination process on the recording sheet; and
when the recording sheet is discharged to the discharge unit, the charge elimination process of the discharged recording sheet is not carried out in the discharge unit, and is carried out by the charge elimination member arranged in the main body.

11. The image forming device according to claim 1, wherein the recording sheet is selectively discharged to the main body discharge section or the discharge unit after printing both sides of the recording sheet.

12. The image forming device according to claim 1, wherein the recording sheet is selectively discharged to the main body discharge section or the discharge unit depending on printing related to copy or printing related to facsimile.

13. The image forming device according to claim 1, wherein the recording sheet is selectively discharged to the main body discharge section or the discharge unit for every print job.
